(19) United States
(12) Patent Application Publication
(10) Pub. No.: US 2026/0359348 A1
(43) Pub. Date: Nov. 12, 2026

(54) PROCESSING APPARATUS, PROCESSING METHOD, AND NON-TRANSITORY COMPUTER-READABLE MEDIUM

(71) Applicant: NEC Corporation, Tokyo (JP)

(72) Inventor: Ryo KAWAI, Tokyo (JP)

(73) Assignee: NEC Corporation, Tokyo (JP)

(21) Appl. No.: 19/140,456

(22) PCT Filed: Dec. 11, 2023
(86) PCT No.: PCT/JP2023/044221

§ 371 Date: Jun. 18, 2025

(30) Foreign Application Priority Data
Dec. 26, 2022 (JP) 2022-207926

(51) Int. Cl. G06F 16/51; G06F 16/532; G06F 16/58

(52) U.S. Cl. CPC G06F 16/51; G06F 16/532; G06F 16/58

(57) ABSTRACT

The present invention provides a processing apparatus including: an acquisition unit that acquires a search query; a search unit that collates the search query with a plurality of sample images, and searches for the sample image matching the search query; a registration unit that registers a result of collation in a collation history indicating one or a plurality of the sample images matching in each time of the collation; and an aggregation output unit that generates and outputs, based on the collation history, aggregation information relating to a result of the collation about a selection sample image among a plurality of the sample images.

### TECHNICAL FIELD

The present invention relates to a processing apparatus, a processing method, and a program.

### BACKGROUND ART

A technique relevant to the present invention is disclosed in Patent Documents 1 and 2. The techniques disclosed in Patent Documents 1 and 2 generate a database storing images indicating a person in various kinds of poses. Then, the technique searches the database for an image matching a search query specified by a user, and outputs the searched image.

### RELATED DOCUMENT

### Patent Document

Patent Document 1: International Patent Publication No. WO2021/084677
Patent Document 2: Japanese Patent Application Publication No. 2019-091138

### SUMMARY

### Technical Problem

In a technique for searching a database for an image matching a search query and outputting the searched image, it is important what kind of images are registered in the database.

By registering a large number and variety of images in a database, probability of searching for an image matching a search query is increased. For example, by registering images of a person in various poses (example: a sitting pose, a standing pose, and the like) in a database, probability of searching for an image matching a search query is increased. Further, by registering not only one image of a certain type (example: an image of a sitting pose) but also a large number of images of a plurality of variations in a database, probability of searching for an image matching a search query is increased.

On the other hand, the larger the number of images registered in a database, the more storage capacity is required to store the images. As a result, cost and burden of labor or the like required for data management are increased.

It is necessary to optimize a group of images to be registered in a database by taking into account such a point and the like. The optimization is, for example, an operation of deleting an excessive image from a database or additionally registering a missing image in a database.

However, a certain number of images are registered in a database. Thus, it is not easy to recognize a whole view of a group of registered images and determine which image is excessively present, what image is missing, or the like. In view of this, a technique for supporting optimization of a group of images registered in a database is desired.

Both of the techniques disclosed in Patent Documents 1 and 2 are techniques for searching a database for an image matching a search query and outputting the searched image. Neither of Patent Documents 1 and 2 can support optimization of a group of images registered in a database.

In view of the above-described problem, one example of an object of the present invention is to provide a processing apparatus, a processing method, and a program that solve a problem of supporting optimization of a group of images registered in a database in a technique for searching a database for an image matching a search query and outputting the searched image.

### Solution to Problem

According to one example aspect of the present invention, provided is a processing apparatus including:
an acquisition unit that acquires a search query;
a search unit that collates the search query with a plurality of sample images, and searches for the sample image matching the search query;
a registration unit that registers a result of the collation in a collation history indicating one or a plurality of the sample images matching in each time of the collation; and
an aggregation output unit that generates and outputs, based on the collation history, aggregation information relating to a result of the collation about a selection sample image among a plurality of the sample images.

According to one example aspect of the present invention, provided is a processing method including,
by one or more computers:
   acquiring a search query;
   collating the search query with a plurality of sample images, and searching for the sample image matching the search query;
   registering a result of the collation in a collation history indicating one or a plurality of the sample images matching in each time of the collation; and
   generating and outputting, based on the collation history, aggregation information relating to a result of the collation about a selection sample image among a plurality of the sample images.

According to one example aspect of the present invention, provided is a program causing a computer to function as:
an acquisition unit that acquires a search query;
a search unit that collates the search query with a plurality of sample images, and searches for the sample image matching the search query;
a registration unit that registers a result of the collation in a collation history indicating one or a plurality of the sample images matching in each time of the collation; and
an aggregation output unit that generates and outputs, based on the collation history, aggregation information relating to a result of the collation about a selection sample image among a plurality of the sample images.

### Advantageous Effects of Invention

According to one example aspect of the present invention, a processing apparatus, a processing method, and a program that solve a problem of supporting optimization of a group of images registered in a database in a technique for searching a database for an image matching a search query and outputting the searched image are achieved.

### BRIEF DESCRIPTION OF THE DRAWINGS

The above-described object and other objects, features, and advantageous effects become more apparent from the suitable example embodiments described below and the following accompanying drawings.

FIG. 1 It is a diagram illustrating one example of a functional block diagram of a processing apparatus.

FIG. 2 It is a diagram illustrating one example of a hardware configuration of the processing apparatus.

FIG. 3 It is a diagram schematically illustrating one example of a collation history generated by the processing apparatus.

FIG. 4 It is a diagram schematically illustrating one example of aggregation information generated by the processing apparatus.

FIG. 5 It is a flowchart illustrating one example of a flow of processing of the processing apparatus.

FIG. 6 It is a flowchart illustrating another example of a flow of processing of the processing apparatus.

FIG. 7 It is a diagram schematically illustrating another example of a collation history generated by the processing apparatus.

FIG. 8 It is a diagram schematically illustrating one example of information output by the processing apparatus.

FIG. 9 It is a diagram schematically illustrating another example of information output by the processing apparatus.

FIG. 10 It is a diagram schematically illustrating another example of information output by the processing apparatus.

FIG. 11 It is a diagram schematically illustrating another example of information output by the processing apparatus.

FIG. 12 It is a diagram schematically illustrating another example of information output by the processing apparatus.

### EXAMPLE EMBODIMENT

Hereinafter, example embodiments of the present invention will be described by using the drawings. Note that, a similar component is assigned with a similar reference sign throughout all the drawings, and description therefor will be omitted as appropriate.

### Example Embodiment 1

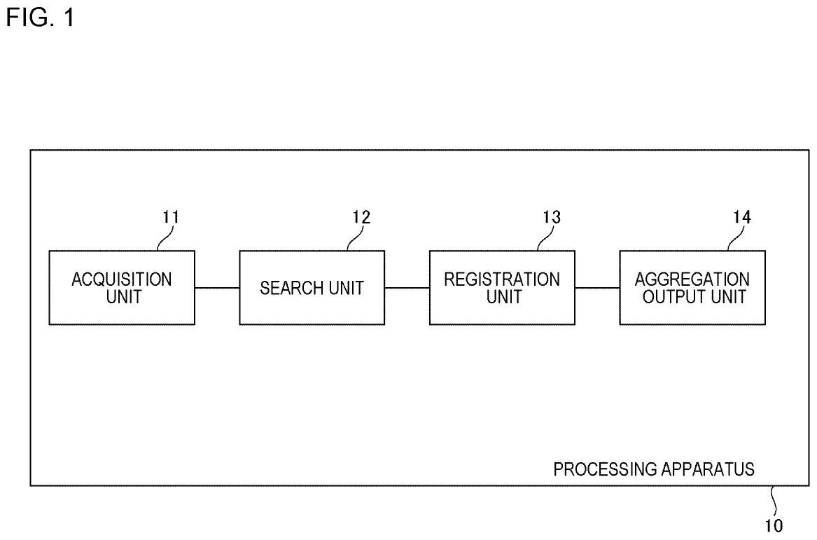

FIG. 1 is a functional block diagram illustrating an overview of a processing apparatus 10 according to a first example embodiment. The processing apparatus 10 includes an acquisition unit 11, a search unit 12, a registration unit 13, and an aggregation output unit 150.

The acquisition unit 11 acquires a search query. The search unit 12 collates the search query with a plurality of sample images and searches for a sample image matching the search query. The registration unit 13 registers a result of collation in a collation history indicating one or a plurality of sample images matching in each time of collation. The aggregation output unit 14 generates and outputs, based on the collation history, aggregation information relating to a result of collation about a selection sample image among the plurality of sample images.

In this way, the processing apparatus 10 performs search processing of searching a database for a sample image matching a search query. Then, the processing apparatus 10 registers a result of collation between the search query and the sample image in each piece of the search processing as a collation history. The processing apparatus 10 generates and outputs, by using the collation history, aggregation information relating to a result of collation for each sample image. The aggregation information indicates, for example, the number or the like of matches in past search processing. A user can determine, based on such aggregation information, which image is excessively present, what image is missing, or the like.

As described above, the processing apparatus 10 according to the present example embodiment can solve a problem of supporting optimization of a group of images registered in a database in a technique for searching a database for an image matching a search query and outputting the searched image.

### Second Example Embodiment

### Overview

A processing apparatus 10 according to the present example embodiment is a specific embodiment of the processing apparatus 10 according to the first example embodiment. In the present example embodiment, a configuration of the processing apparatus 10 is embodied. Further, in the present example embodiment, the “aggregation information” described in the first example embodiment is embodied.

### Hardware Configuration

Next, one example of a hardware configuration of the processing apparatus 10 will be described. Each function unit of the processing apparatus 10 is achieved by any combination of hardware and software. It is to be understood by a person skilled in the art that there are a variety of modified examples of a method or an apparatus for achieving the same. The software includes a program stored in advance in a stage of shipping an apparatus, a program downloaded from a medium such as a compact disc (CD), a server on the Internet, or the like, and the like.

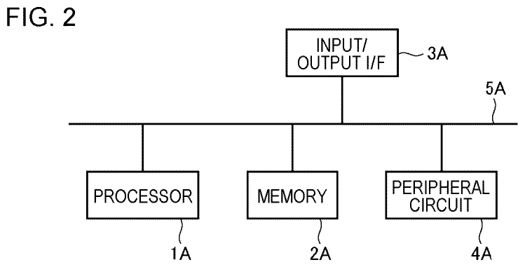

FIG. 2 is a block diagram illustrating a hardware configuration of the processing apparatus 10. As illustrated in FIG. 2, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured by a plurality of physically and/or logically separated apparatuses. In this case, each of the plurality of apparatuses can include the above hardware configuration.

The bus 5A is a data transmission path through which the processor 1A, the memory 2A, the peripheral circuit 4A, and the input/output interface 3A transmit and receive data to and from one another. The processor 1A is an arithmetic processing apparatus such as, for example, a CPU or a graphics processing unit (GPU). The memory 2A is a memory such as, for example, a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. Further, the input/output interface 3A includes an interface for connecting to a communication network such as the Internet. The input apparatus is, for example, a keyboard, a mouse, a microphone, a physical button, a touch panel, and the like. The output apparatus is, for example, a display, a speaker, a printer, a mailer, and the like. The processor 1A can give an instruction to each module to perform an operation, based on an operation result thereof.

### Functional Configuration

Next, a functional configuration of the processing apparatus 10 according to the present example embodiment will be described in detail. FIG. 1 illustrates one example of a functional block diagram of the processing apparatus 10. As illustrated, the processing apparatus 10 includes an acquisition unit 11, a search unit 12, a registration unit 13, and an aggregation output unit 14.

The acquisition unit 11 acquires a search query. The search query is, for example, a query image. The query image may be a still image, or may be a moving image. Besides the above, the search query may be data indicating a feature of the query image with a text or the like. The feature of the query image is a feature of an object captured in the query image. The object captured in the query image is, but not limited to, a person, other animals, an architectural object, a natural object, an artificial object, or the like. The feature of the object captured in the query image is, but not limited to, a feature of a face, a feature of a body, a feature of clothes, a feature of belongings, a feature of a pose, a feature of a gait, a feature of a motion, a movement trajectory, a size, a position, a color, a shape, information on a keypoint, or the like.

Herein, one example of a means whereby the acquisition unit 11 acquires a search query will be described. For example, a user may input a search query via an input apparatus of the processing apparatus 10. Then, the acquisition unit 11 may acquire the input search query. Besides the above, the processing apparatus 10 may be a server. Then, the acquisition unit 11 may acquire a search query transmitted from a client terminal. Besides the above, an image generated by a surveillance camera may be input to the processing apparatus 10. Then, the acquisition unit 11 may acquire the image generated by the surveillance camera as a search query. Note that, a means whereby the acquisition unit 11 acquires a search query is not limited to the example described herein.

The search unit 12 searches for a sample image matching the search query acquired by the acquisition unit 11.

A plurality of sample images according to search purposes are stored in advance in a storage apparatus. For example, in a case where the search purpose is “search for an image in which a person in a pose indicated by a search query is captured”, sample images of a person in various poses are stored in a storage apparatus. Further, in a case where the search purpose is “determination of a location where an image is taken”, sample images taken at various locations are stored in a storage apparatus. Note that, the processing apparatus 10 may include the above storage apparatus. Besides the above, an external apparatus configured communicably with the processing apparatus 10 may include the above storage apparatus.

The search unit 12 collates the search query acquired by the acquisition unit 11 with each of the plurality of sample images and computes a degree of similarity. Then, the search unit 12 determines, based on the computed degree of similarity, a sample image matching the search query. A condition for matching the search query is “the degree of similarity being equal to or more than a reference value”. Note that, the collation and the computation of the degree of similarity are achieved by using any conventional technique. For example, the technique described in Patent Document 1 can be used.

The registration unit 13 registers a result of collation by the search unit 12 in a collation history indicating one or a plurality of sample images matching in each time of collation.

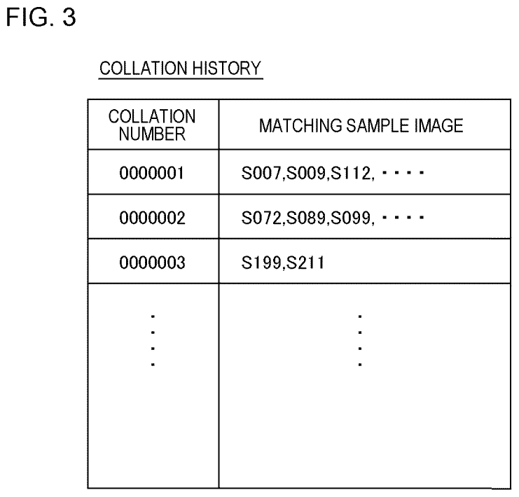

FIG. 3 schematically illustrates one example of a collation history. In the illustrated collation history, a collation number and a matching sample image are associated with each other.

The “collation number” is information mutually identifying a plurality of times of collation performed hitherto.

In a field of the “matching sample image”, identification information of a sample image matching a search query in each time of collation is registered.

As described above, a condition for matching the search query is “the degree of similarity being equal to or more than a reference value”. Thus, there is a case where a plurality of sample images match simultaneously in each time of collation, as illustrated in FIG. 3.

Returning to FIG. 1, the aggregation output unit 14 generates and outputs, based on the collation history, aggregation information relating to a result of collation about a selection sample image among the plurality of sample images.

The selection sample image is at least one sample image selected from among the plurality of sample images. The selection may be performed by a user. Besides the above, the selection may be performed by the aggregation output unit 14 according to any rule determined in advance. An example in which the selection is performed by a user will be described in detail in the following example embodiment.

The aggregation information relating to the selection sample image indicates at least one of the following pieces of information.
The number of times of matching
A matching rate
A statistical value for the number of other sample images that match simultaneously
Other sample images that have matched simultaneously
The number of times of simultaneous matching with each of other sample images that have matched simultaneously
A sample image with the number of times of simultaneous matching satisfying a predetermined condition among other sample images that have matched simultaneously
A degree of similarity to other sample images that have matched simultaneously

The “number of times of matching” is the number of times of matching the search query in the plurality of times of collation indicated by the collation history illustrated in FIG. 3. The number of times of matching is computed by, for example, counting the number of times the identification information of the selection sample image is registered in the field of the “matching sample image” in the collation history illustrated in FIG. 3.

The “matching rate” is computed by dividing the above-described number of times of matching by the total number of times of collation indicated by the collation history illustrated in FIG. 3.

The “statistical value for the number of other sample images that match simultaneously” is a statistical value for the number of other sample images matching simultaneously upon matching of the selection sample image. The statistical value is a mean, a maximum, a minimum, a median, a mode, or the like. As described above, a condition for matching the search query is “the degree of similarity being equal to or more than a reference value”. Thus, there is a case where a plurality of sample images match simultaneously in each time of collation, as illustrated in FIG. 3.

The “other sample images that have matched simultaneously” are sample images that have matched simultaneously with the selection sample image.

The “number of times of simultaneous matching with each of other sample images that have matched simultaneously” indicates the number of times of simultaneous matching with the selection sample image for each of the sample images that have matched simultaneously with the selection sample image.

The “sample image with the number of times of simultaneous matching satisfying a predetermined condition among other sample images that have matched simultaneously” is a sample image with the number of times of simultaneous matching with the selection sample image satisfying a predetermined condition. The predetermined condition is, for example, being equal to or more than a predetermined number of times. Besides the above, other sample images may be ranked in descending order of the number of times of simultaneous matching with the selection sample image. Then, being within a predetermined top-rank proportion, within a predetermined top-rank number, or within a reference rank in the ranking may be set as the predetermined condition.

The “degree of similarity to other sample images that have matched simultaneously” is a degree of similarity between the selection sample image and each of other sample images that have matched simultaneously with the selection sample image. Computation of the degree of similarity between the two images is achieved by using any conventional technique.

The aggregation output unit 14 generates aggregation information relating to the selection sample image as described above, based on the collation history as illustrated in FIG. 3. Then, the aggregation output unit 14 outputs the generated aggregation information relating to the selection sample image. For example, the aggregation output unit 14 may output the aggregation information via an output apparatus such as a display, a projection apparatus, or a printer. Besides the above, the processing apparatus 10 may be a server. Then, the aggregation output unit 14 may transmit the aggregation information to a client terminal. In this case, an output apparatus of the client terminal outputs the aggregation information.

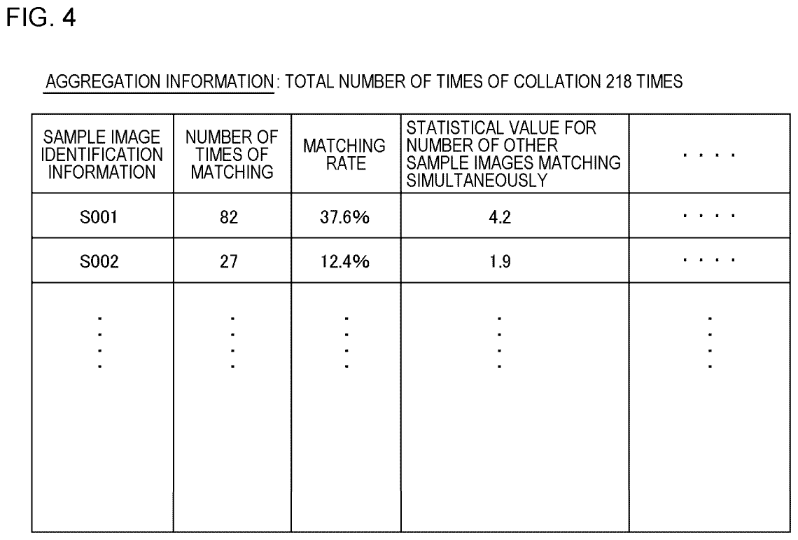

Note that, each time a selection sample image is selected from among a plurality of sample images, the aggregation output unit 14 may generate and output aggregation information relating to the selection sample image. Besides the above, the aggregation output unit 14 may generate aggregation information of each of a plurality of sample images in advance, based on a latest collation history, as illustrated in FIG. 4. Then, once a selection sample image is selected from among the plurality of sample images, the aggregation output unit 14 may extract and output aggregation information of the selection sample image from among pieces of aggregation information of each of the plurality of sample images.

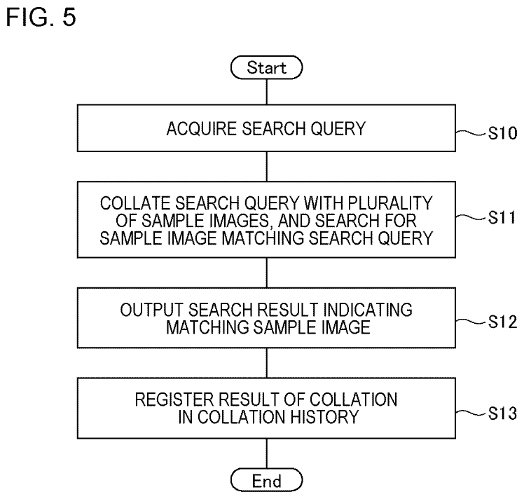

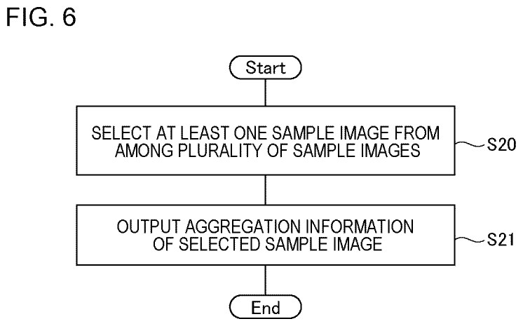

Next, one example of a flow of processing of the processing apparatus 10 will be described by using flowcharts in FIGS. 5 and 6.

First, one example of a flow of processing of generating a collation history as illustrated in FIG. 3 will be described by using a flowchart in FIG. 5.

Upon acquiring a search query (S10), the processing apparatus 10 collates the search query with a plurality of sample images and searches for a sample image matching the search query (S11). Next, the processing apparatus 10 outputs a result of search indicating a matching sample image (S12). Further, the processing apparatus 10 registers a result of collation in S11 in a collation history indicating one or a plurality of sample images matching in each time of collation (S13). Note that, processing order of S12 and S13 is not limited to the example in FIG. 5. S13 may be performed prior to S12, or S12 and S13 may be performed concurrently.

Next, one example of a flow of processing of outputting aggregation of a selection sample image will be described by using a flowchart in FIG. 6.

The processing apparatus 10 selects at least one sample image from among a plurality of sample images (S20). For example, the processing apparatus 10 may perform the selection, based on a user input. Besides the above, the processing apparatus 10 may select at least one sample image from among a plurality of sample images according to any rule determined in advance.

Next, the processing apparatus 10 outputs aggregation information of the selected sample image (S21).

### Advantageous Effect

The processing apparatus 10 according to the present example embodiment collates a search query with a plurality of sample images and searches for a sample image matching the search query. Then, the processing apparatus 10 generates a collation history indicating one or a plurality of sample images matching in each time of collation. The processing apparatus 10 generates and outputs, based on the collation history, aggregation information relating to a result of collation about a selection sample image.

A user can recognize, based on the output aggregation information, an overview of the result of collation of the selection sample image performed hitherto. Then, the user can determine, based on the recognized content, whether to keep or delete the selection sample image as a sample image or the like. Further, the user can determine, based on the recognized content, whether to keep, delete, or add a variation image of the selection sample image or the like.

The variation image of the selection sample image is an image of the same type as the selection sample image. For example, in a case where the selection sample image is an image including a person in a sitting pose, the variation image of the selection sample image is also an image including a person in a sitting pose. The selection sample image and the variation image of the selection sample image are not completely consistent with each other, but have at least one attribute different from each other. The attribute is, for example, but not limited to, gender of a person, an age group, photographing time of a day, a photographing location, a sitting position, orientation of a person, or the like.

Further, the processing apparatus 10 according to the present example embodiment can generate and output characteristic aggregation information.

The aggregation information of the selection sample image indicates, for example, the number of times of matching. In a case where the number of times of matching is large, the selection sample image can be considered to be of high importance. Then, in a case where the number of times of matching is small, the selection sample image can be considered to be of low importance. Further, in a case where the number of times of matching is small, the selection sample image is an outlier in a group of sample images and may possibly be a cause of erroneous detection. In view of this, in a case where the number of times of matching is equal to or less than a threshold value, the selection sample image may be deleted from the sample images.

Further, the aggregation information of the selection sample image indicates, for example, a matching rate. In a case where the matching rate is high, the selection sample image can be considered to be of high importance. Then, in a case where the matching rate is low, the selection sample image can be considered to be of low importance. Further, in a case where the matching rate is low, the selection sample image is an outlier in a group of sample images and may possibly be a cause of erroneous detection. In view of this, in a case where the matching rate is equal to or less than a threshold value, the selection sample image may be deleted from the sample images.

Further, the aggregation information of the selection sample image indicates, for example, a statistical value for the number of other sample images that match simultaneously. In a case where there are a large number of other sample images that match simultaneously, it can be considered that a sufficient number of variation images of the selection sample image are registered. On the other hand, in a case where there are an excessive number of other sample images that match simultaneously, it can be considered that an unnecessarily large number of variation images of the selection sample image are registered. In this case, the selection sample image and some of the variation images of the selection sample image may be deleted from the sample images.

Further, in a case where there are a small number of other sample images that match simultaneously, it can be considered that variation images of the selection sample image are insufficient. In view of this, an additional variation image of the selection sample image may be registered. Besides the above, in a case where there are a small number of other sample images that match simultaneously, the selection sample image is an outlier in a group of sample images and may possibly be a cause of erroneous detection. In view of this, in a case where there are a small number of other sample images that match simultaneously, the selection sample image may be deleted from the sample images.

Further, the aggregation information of the selection sample image indicates, for example, other sample images that have matched simultaneously. By viewing other sample images that have matched simultaneously, variation images of the selection sample image can be recognized. Then, in a case where there are an excessive number of variation images of the selection sample image, the selection sample image and some of other sample images that have matched simultaneously with the selection sample image may be deleted from the sample images.

Further, the aggregation information of the selection sample image indicates, for example, the number of times of simultaneous matching with each of other sample images that have matched simultaneously. In a case where the number is extremely large, it can be considered as redundant that both the other sample image and the selection sample image are registered as the sample images since a degree of similarity therebetween is too high. Thus, for example, any of other sample images with the number being equal to or more than a threshold value and the selection sample image may be deleted from the sample images.

Further, the aggregation information of the selection sample image can indicate a sample image with the number of times of simultaneous matching satisfying a predetermined condition among other sample images that have matched simultaneously. The predetermined condition is being equal to or more than a predetermined number of times, within a predetermined top-rank proportion, within a predetermined top-rank number, within a reference rank, or the like, as described above. In a case where the number of times of simultaneous matching is extremely large, it can be considered as redundant that both the other sample image and the selection sample image are registered as the sample images since a degree of similarity therebetween is too high. Thus, for example, any of other sample images satisfying the predetermined condition and the selection sample image may be deleted from the sample images.

Further, the aggregation information of the selection sample image indicates a degree of similarity to other sample images that have matched simultaneously. For example, any of other sample images to which a degree of similarity is equal to or more than a threshold value and the selection sample image may be deleted from the sample images.

### Third Example Embodiment

A processing apparatus 10 according to the present example embodiment includes a function of generating aggregation information different from the aggregation information described in the second example embodiment. Hereinafter, description will be given in detail.

A search unit 12 searches for a sample image with a degree of similarity to a search query being equal to or more than a reference value, as a sample image matching the search query. Then, the search unit 12 ranks the sample image matching the search query in descending order of the degree of similarity to the search query.

A registration unit 13 further registers the above rank in a collation history indicating one or a plurality of sample images matching in each time of collation.

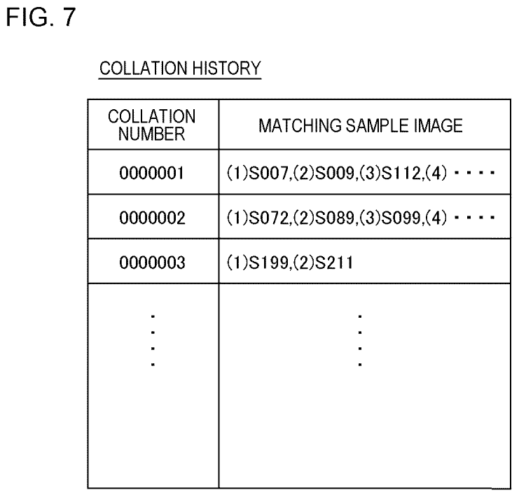

FIG. 7 schematically illustrates one example of a collation history generated by the registration unit 13 according to the present example embodiment. In the illustrated collation history, a collation number and a matching sample image are associated with each other, similarly to the collation history in FIG. 3 described in the second example embodiment.

In a field of the “collation number”, a content similar to the collation history in FIG. 3 described in the second example embodiment is registered.

In a field of the “matching sample image”, identification information of a sample image matching a search query in each time of collation is registered. Then, a parenthesized number illustrated therein indicates a rank of the sample image matching the search query in descending order of a degree of similarity to the search query.

An aggregation output unit 14 generates and outputs aggregation information relating to a selection sample image.

The aggregation information relating to the selection sample image indicates, in addition to or instead of the information described in the second example embodiment, at least one of the following pieces of information.
A statistical value for a rank upon matching
A statistical value for a rank upon simultaneous matching of each of other sample images that have matched simultaneously
A statistical value for a rank difference between a rank upon matching and a rank upon simultaneous matching of each of other sample images that have matched simultaneously
A history of a pair of ranks of other sample images that have matched simultaneously and the selection sample image

The “statistical value for a rank upon matching” is a statistical value for a rank of the selection sample image upon matching of the selection sample image. The rank is a rank in descending order of the degree of similarity to the search query described above. The statistical value is a mean, a maximum, a minimum, a median, a mode, or the like.

The “statistical value for a rank upon simultaneous matching of each of other sample images that have matched simultaneously” is a value computed for each of other sample images that have matched simultaneously with the selection sample image. The value is a statistical value for a rank upon simultaneous matching with the selection sample image. The rank is a rank in descending order of the degree of similarity to the search query described above. The statistical value is a mean, a maximum, a minimum, a median, a mode, or the like.

The “statistical value for a rank difference between a rank upon matching and a rank upon simultaneous matching of each of other sample images that have matched simultaneously” is a value computed for each of other sample images that have matched simultaneously with the selection sample image. The rank difference is a difference in ranks between each other upon simultaneous matching.

That is, the rank difference is a value acquired by subtracting a rank of the other sample image from a rank of the selection sample image upon simultaneous matching. For example, in a case where a rank of the selection sample image is second place and a rank of the other sample image is fourth place upon simultaneous matching, the rank difference is “−2”.

Note that, the rank difference may be a value acquired by subtracting a rank of the selection sample image from a rank of the other sample image upon simultaneous matching. For example, in a case where a rank of the selection sample image is second place and a rank of the other sample image is fourth place upon simultaneous matching, the rank difference is “2”.

Besides the above, the rank difference may be an absolute value of a difference between a rank of the selection sample image and a rank of the other sample image upon simultaneous matching. For example, in a case where a rank of the selection sample image is second place and a rank of the other sample image is fourth place upon simultaneous matching, the rank difference is “2”.

The rank is a rank in descending order of the degree of similarity to the search query described above. The statistical value is a mean, a maximum, a minimum, a median, a mode, or the like.

The “history of a pair of ranks of other sample images that have matched simultaneously and the selection sample image” indicates a history of a pair of a rank of the other sample image upon simultaneous matching and a rank of the selection sample image. The rank is a rank in descending order of the degree of similarity to the search query described above.

Other configurations of the processing apparatus 10 according to the present example embodiment are similar to the configurations of the processing apparatus 10 according to the first and second example embodiments.

The processing apparatus 10 according to the present example embodiment achieves an advantageous effect similar to the processing apparatus 10 according to the first and second example embodiments.

Further, the processing apparatus 10 according to the present example embodiment can generate and output characteristic aggregation information.

The aggregation information of the selection sample image indicates, for example, a statistical value for a rank upon matching. Further, the aggregation information of the selection sample image indicates, for example, a statistical value for a rank upon simultaneous matching of each of other sample images that have matched simultaneously. Further, the aggregation information of the selection sample image indicates a statistical value for a rank difference between a rank upon matching and a rank upon simultaneous matching of each of other sample images that have matched simultaneously. Further, the aggregation information of the selection sample image indicates a history of a pair of ranks of other sample images that have matched simultaneously and the selection sample image.

It can be considered the higher a rank upon matching, the more important among a group of variation images. Then, it can be considered the lower a rank upon matching, the less important among a group of variation images. In view of this, a sample image with a relatively low rank upon matching among a group of variation images may be deleted from the sample images.

### Fourth Example Embodiment

A processing apparatus 10 according to the present example embodiment uses a specifically embodied method of outputting aggregation information of a selection sample image. Hereinafter, description will be given in detail.

An aggregation output unit 14 acquires a feature value of each of a plurality of sample images. The feature value of each sample image is indicated by a multi-dimensional vector. For example, the feature value of each sample image is indicated by a three or more-dimensional vector.

Then, the aggregation output unit 14 reduces dimensionality of the feature value of each of the sample images indicated by a multi-dimensional vector. For example, the aggregation output unit 14 reduces dimensionality of the feature value of each of the sample images indicated by a three or more-dimensional vector to a two-dimensional vector. A means for dimensionality reduction is not particularly limited, but an approach such as, for example, t-distributed stochastic neighbor embedding (t-SNE) can be employed.

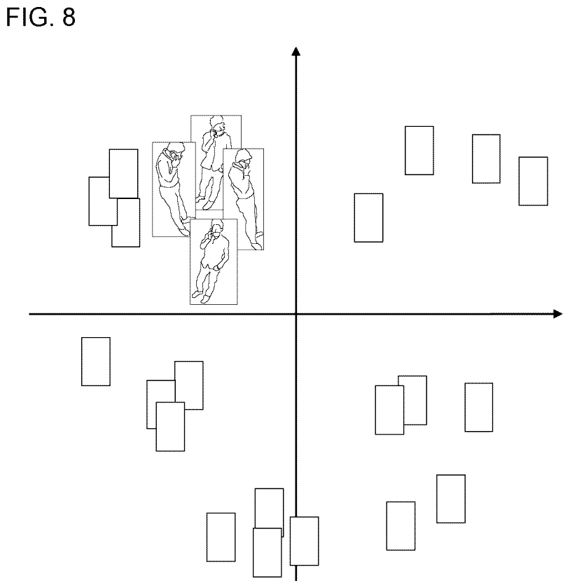

Then, the aggregation output unit 14 generates and outputs distribution information of a plurality of sample images plotted on a reduced-dimensional graph. FIG. 8 illustrates one example of distribution information. In the illustrated example, a plurality of sample images are plotted on a two-dimensional graph. Note that, in the figure, image contents of only some sample images are illustrated, and only image contours of other sample images are schematically illustrated. In practice, image contents of all sample images can be illustrated. As another example, marks such as circles or stars may be plotted on a graph instead of sample images.

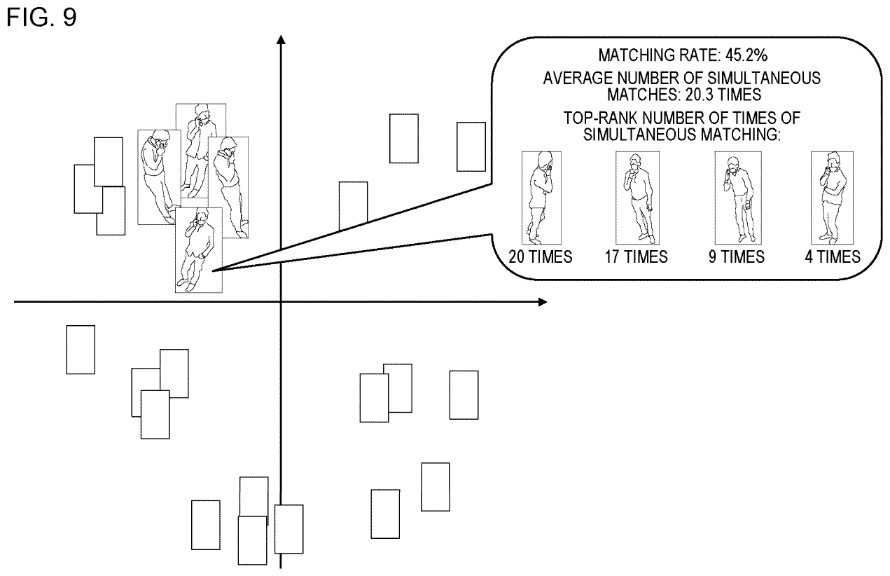

The aggregation output unit 14 can accept an input of selecting a selection sample image on such a graph. Then, the aggregation output unit 14 can output, in response to the input, aggregation information of the selected selection sample image, as illustrated in FIG. 9. In FIG. 9, the selected selection sample image is illustrated by using a word balloon. Further, the aggregation information of the selection sample image is illustrated by using the word balloon.

The illustrated aggregation information of the selection sample image indicates a matching rate. Further, the illustrated aggregation information of the selection sample image indicates a mean of the number of other sample images that match simultaneously (the illustrated “average number of simultaneous matches”). Further, the illustrated aggregation information of the selection sample image indicates a sample image (in the figure, four sample images in the word balloon) with the number of times of simultaneous matching satisfying a predetermined condition (within top 4 ranks). Further, the illustrated aggregation information of the selection sample image indicates the number of times of simultaneous matching (in the figure, numerical values next to the four sample images in the word balloon) with each of other sample images that have matched simultaneously. Note that, the illustrated aggregation information of the selection sample image is one example. The aggregation output unit 14 may indicate other pieces of aggregation information described in the second and third example embodiments.

Incidentally, it requires a great deal of effort to select one by one among a plurality of sample images as illustrated in FIG. 9 and check the aggregation information. In view of this, the aggregation output unit 14 may highlight a sample image satisfying a predetermined highlighting condition among sample images plotted on a graph as illustrated in FIG. 9. A user can select the highlighted sample image preferentially and check the aggregation information.

An approach for highlighting is not particularly limited. For example, only a sample image to be highlighted may be enclosed in a frame. Besides the above, only a sample image to be highlighted may be blinked. Besides the above, a sample image to be highlighted may be displayed larger than other sample images.

The highlighting condition is defined by using a value for a predetermined item indicated by the aggregation information. Examples of the highlighting condition include, for example, “the number of times of matching being equal to or less than M”, “a matching rate being equal to or less than N”, and the like. Note that, the highlighting condition may be defined by using values for a plurality of items indicated by the aggregation information. Such a highlighting condition is, for example, “the number of times of matching being equal to or less than M and a mean of the number of other sample images that match simultaneously being equal to or less than P” or the like.

The highlighting condition may be set in advance. Besides the above, a user may set the highlighting condition. That is, the aggregation output unit 14 may set the highlighting condition, based on a user input.

Other configurations of the processing apparatus 10 according to the present example embodiment are similar to the configurations of the processing apparatus 10 according to the first to third example embodiments.

The processing apparatus 10 according to the present example embodiment achieves an advantageous effect similar to the processing apparatus 10 according to the first to third example embodiments.

Further, the processing apparatus 10 according to the present example embodiment can output aggregation information of a selection sample image with a characteristic approach as illustrated in FIGS. 8 and 9. Specifically, the processing apparatus 10 can generate and output distribution information of a plurality of sample images plotted on a reduced-dimensional graph after reducing dimensionality of a feature value of each of the sample images indicated by a multi-dimensional vector.

In a case of distribution information of a plurality of sample images plotted on a multi-dimensional graph, a user has difficulty in recognizing a distribution status of the plurality of sample images. In a case of distribution information of a plurality of sample images plotted on a reduced-dimensional graph after dimensionality reduction, a user can easily recognize a distribution status of the plurality of sample images.

However, in a case of distribution information of a plurality of sample images plotted on a reduced-dimensional graph, a detail of a distribution status of a plurality of sample images cannot be accurately recognized although an overview thereof can be recognized. For example, a situation may arise where a plurality of sample images appear to be close to each other on a graph, but are not very close in reality.

In view of the above, the processing apparatus 10 according to the present example embodiment displays aggregation information of a selection sample image selected from among sample images plotted on a graph, as illustrated in FIG. 9. A user can perform various determinations, based on a distribution information indicated by the graph and the aggregation information of the selected sample image.

### Fifth Example Embodiment

A processing apparatus 10 according to the present example embodiment outputs aggregation information of a selection sample image with an approach different from the fourth example embodiment. Hereinafter, description will be given in detail.

An aggregation output unit 14 rank-displays a plurality of sample images, based on a value for a predetermined item indicated by aggregation information. Then, the aggregation output unit 14 accepts an input of selecting a selection sample image from among the plurality of rank-displayed sample images. Then, the aggregation output unit 14 outputs aggregation information relating to the selected selection sample image.

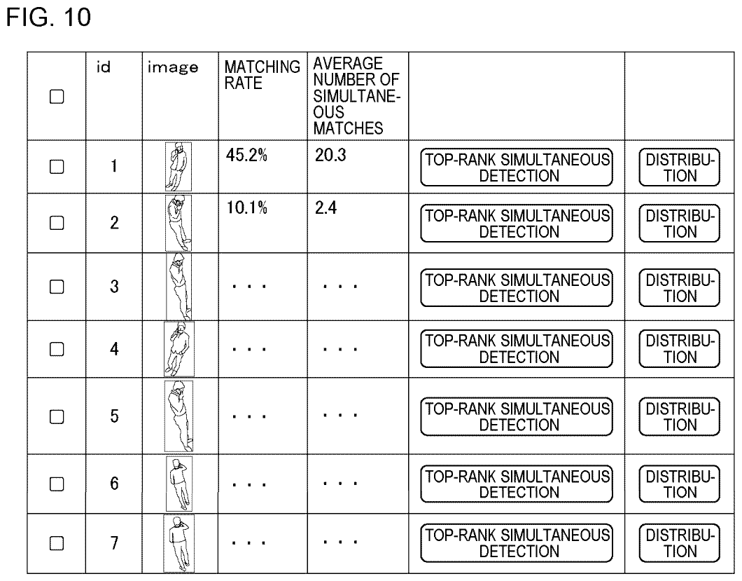

FIG. 10 illustrates one example. In FIG. 10, a plurality of sample images are rank-displayed in descending order of a matching rate. Note that, rank display may be performed based on a value for other items. Further, a user may specify an item for use in ranking.

Incidentally, in the rank display as illustrated in FIG. 10, displaying values for all items indicated by the aggregation information at the same time would result in information overload, making it difficult to recognize contents. In view of this, in the example illustrated in FIG. 10, a value for a first item among a plurality of items indicated by the aggregation information is displayed in the rank display. Then, a value for a second item among a plurality of items indicated by the aggregation information is displayed according to selection of one sample image (selection sample image).

That is, in the example illustrated in FIG. 10, the aggregation output unit 14 displays, in the rank display, the value for the first item indicated by the aggregation information in association with each of the plurality of sample images. In FIG. 10, the matching rate and an average number of simultaneous matches are the first item. Note that, the first item is not limited to the example.

Then, in the example illustrated in FIG. 10, the aggregation output unit 14 is configured to display the value for the second item indicated by the aggregation information according to selection by a user. In FIG. 10, “a sample image with the number of times of simultaneous matching satisfying a predetermined condition (within a predetermined top-rank number) among other sample images that have matched simultaneously” (in the figure, “top-rank simultaneous detection”) is the second item. Note that, the second item is not limited to the example.

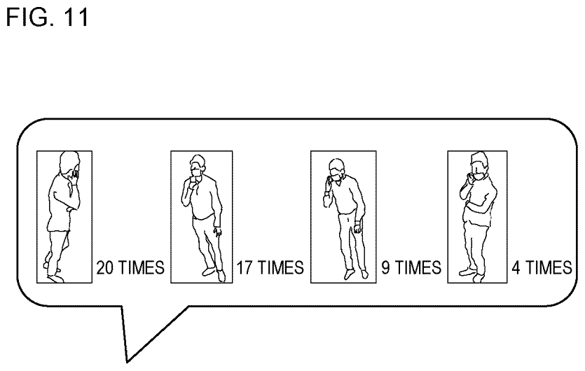

In FIG. 10, one sample image is selected as a selection sample image by operating a button of “top-rank simultaneous detection”. Once the button of “top-rank simultaneous detection” is operated, a sample image with the number of times of simultaneous matching satisfying a predetermined condition (within a predetermined top-rank number) among other sample images that have matched simultaneously with the selection sample image” is output, as illustrated in FIG. 11.

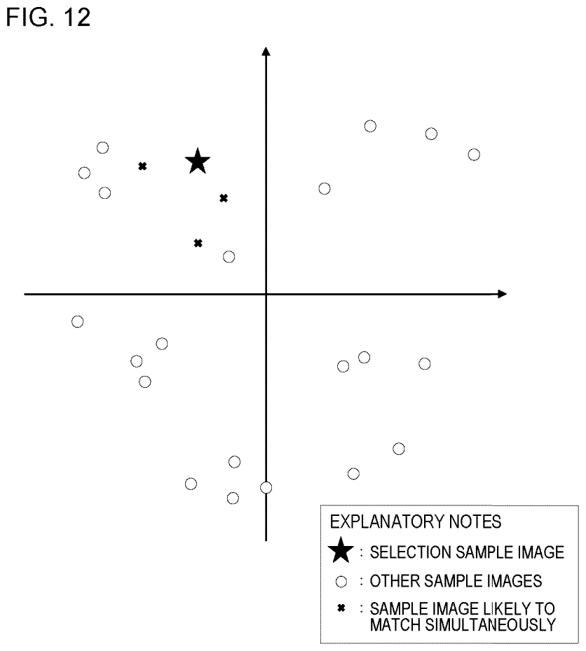

Further, in the example illustrated in FIG. 10, “distribution information of a plurality of sample images plotted on a reduced-dimensional graph after reducing dimensionality of a feature value of each of the sample images indicated by a multi-dimensional vector” described in the fourth example embodiment is output by operating a button of “distribution”. FIG. 12 illustrates one example of distribution information to be output. In the illustrated example, a selection sample image, a sample image likely to match simultaneously with the selection sample image, and other sample images are displayed separately.

Note that, the aggregation output unit 14 may perform highlighting described in the fourth example embodiment also in the rank display as illustrated in FIG. 10. An approach for highlighting is similar to the approach described in the fourth example embodiment.

Other configurations of the processing apparatus 10 according to the present example embodiment are similar to the configurations of the processing apparatus 10 according to the first to third example embodiments.

The processing apparatus 10 according to the present example embodiment achieves an advantageous effect similar to the processing apparatus 10 according to the first to third example embodiments.

Further, the processing apparatus 10 according to the present example embodiment can output aggregation information of a selection sample image with a characteristic approach as illustrated in FIGS. 10 to 12. Specifically, the processing apparatus 10 can rank-display a plurality of sample images, based on a value for a predetermined item indicated by aggregation information. Then, the processing apparatus 10 can output aggregation information relating to a selection sample image selected from among the plurality of rank-displayed sample images. A user can recognize, based on the output information, a whole view of the plurality of sample images or a detail of each sample image.

### Modified Example

The processing apparatus 10 may include a function of deleting a sample image specified by a user from among sample images stored in a storage apparatus. For example, a button for deleting a selection sample image may be displayed in information (word balloon) displayed in association with the selection sample image as illustrated in FIG. 9. Then, the processing apparatus 10 may delete, in response to an operation of the button, the selection sample image from among sample images stored in a storage apparatus.

Further, the processing apparatus 10 may display, in the rank display as illustrated in FIG. 10, a button for deleting each sample image in association with each sample image. Then, the processing apparatus 10 may delete, in response to an operation of the button, a selected sample image from among sample images stored in a storage apparatus.

Further, the processing apparatus 10 may include a function of collectively specifying and deleting a plurality of sample images. For example, the processing apparatus 10 may accept, in the distribution information as illustrated in FIGS. 8, 9, and 12, a user input of specifying an area on a graph. Then, the processing apparatus 10 may delete, in response to a subsequent deletion instruction from a user, one or a plurality of sample images present within the specified area from among sample images stored in a storage apparatus.

While the example embodiments of the present invention have been described above with reference to the drawings, the example embodiments are exemplifications of the present invention, and various configurations other than the above can be employed. The configurations of the above-described example embodiments may be combined with each other, or a part of the configurations may be replaced with another configuration. Further, various modifications may be applied to the configurations of the above-described example embodiments, as long as such modifications do not depart from the gist. Further, the configurations and processing disclosed in the above-described example embodiments and the modified example may be combined with each other.

Further, a plurality of processes (pieces of processing) are described in order in the plurality of flowcharts used in the above description. However, execution order of processes executed in each example embodiment is not limited to the described order. The order of the illustrated processes can be changed in each example embodiment, as long as the change does not detract from contents. Further, the above example embodiments can be combined, as long as contents do not contradict each other.

The whole or part of the above-described example embodiments can be described as, but not limited to, the following supplementary notes.

1. A processing apparatus including:
an acquisition unit that acquires a search query;
a search unit that collates the search query with a plurality of sample images, and searches for the sample image matching the search query;
a registration unit that registers a result of the collation in a collation history indicating one or a plurality of the sample images matching in each time of the collation; and
an aggregation output unit that generates and outputs, based on the collation history, aggregation information relating to a result of the collation about a selection sample image among a plurality of the sample images.

2. The processing apparatus according to supplementary note 1, wherein
the search unit
   searches for, as the sample image matching the search query, the sample image with a degree of similarity to the search query being equal to or more than a reference value, and
the aggregation information relating to the selection sample image
   indicates at least one of a number of times of matching, a matching rate, a statistical value for a number of the other sample images that match simultaneously, the other sample images that have matched simultaneously, a number of times of simultaneous matching with each of the other sample images that have matched simultaneously, the sample image with a number of times of simultaneous matching satisfying a predetermined condition among the other sample images that have matched simultaneously, and a degree of similarity to the other sample images that have matched simultaneously.

3. The processing apparatus according to supplementary note 1 or 2, wherein
the search unit
   searches for, as the sample image matching the search query, the sample image with a degree of similarity to the search query being equal to or more than a reference value, and ranks the sample image matching the search query in descending order of the degree of similarity, and
the aggregation information relating to the selection sample image
   indicates at least one of a statistical value for the rank upon matching, a statistical value for the rank upon simultaneous matching of each of the other sample images that have matched simultaneously, a statistical value for a rank difference between the rank upon matching and the rank upon simultaneous matching of each of the other sample images that have matched simultaneously, and a history of a pair of the ranks of the other sample images that have matched simultaneously and the selection sample image.

4. The processing apparatus according to any one of supplementary notes 1 to 3, wherein
the aggregation output unit
   generates and outputs distribution information of a plurality of the sample images plotted on a reduced-dimensional graph after reducing dimensionality of a feature value of each of the sample images indicated by a multi-dimensional vector,
   accepts an input of selecting the selection sample image on the graph, and
   outputs the aggregation information relating to the selected selection sample image.

5. The processing apparatus according to supplementary note 4, wherein
the aggregation output unit
   highlights the sample image with a value for a predetermined item indicated by the aggregation information satisfying a highlighting condition among the sample images plotted on the graph.

6. The processing apparatus according to supplementary note 5, wherein
the aggregation output unit
   sets the highlighting condition, based on a user input.

7. The processing apparatus according to any one of supplementary notes 1 to 6, wherein
the aggregation output unit
   rank-displays a plurality of the sample images, based on a value for a predetermined item indicated by the aggregation information,
   accepts an input of selecting the selection sample image from among the rank-displayed plurality of the sample images, and
   outputs the aggregation information relating to the selected selection sample image.

8. The processing apparatus according to supplementary note 7, wherein
the aggregation output unit
   displays, in the rank display, a value for a first item indicated by the aggregation information in association with each of a plurality of the sample images, and
   displays, as the aggregation information relating to the selected selection sample image, a value for a second item indicated by the aggregation information.

9. A processing method including,
by one or more computers:
   acquiring a search query;
   collating the search query with a plurality of sample images, and searching for the sample image matching the search query;
   registering a result of the collation in a collation history indicating one or a plurality of the sample images matching in each time of the collation; and
   generating and outputting, based on the collation history, aggregation information relating to a result of the collation about a selection sample image among a plurality of the sample images.

10. A program causing a computer to function as:
an acquisition unit that acquires a search query;
a search unit that collates the search query with a plurality of sample images, and searches for the sample image matching the search query;
a registration unit that registers a result of the collation in a collation history indicating one or a plurality of the sample images matching in each time of the collation; and
an aggregation output unit that generates and outputs, based on the collation history, aggregation information relating to a result of the collation about a selection sample image among a plurality of the sample images.

This application is based upon and claims the benefit of priority from Japanese patent application No. 2022-207926, filed on Dec. 26, 2022, the disclosure of which is incorporated herein in its entirety by reference.

### REFERENCE SIGNS LIST

10 Processing apparatus
11 Acquisition unit
12 Search unit
13 Registration unit
14 Aggregation output unit
1A Processor
2A Memory
3A Input/output I/F
4A Peripheral circuit
5A Bus

What is claimed is:

1. A processing apparatus comprising:
at least one memory configured to store one or more instructions; and
at least one processor configured to execute the one or more instructions to:
acquire a search query;
collate the search query with a plurality of sample images;
search for the sample image matching the search query;
register a result of the collation in a collation history indicating one or a plurality of the sample images matching in each time of the collation;
generate, based on the collation history, aggregation information relating to a result of the collation about a selection sample image among a plurality of the sample images; and
output the aggregation information.

2. The processing apparatus according to claim 1, wherein the at least one processor is further configured to execute the one or more instructions to
search for, as the sample image matching the search query, the sample image with a degree of similarity to the search query being equal to or more than a reference value, and
the aggregation information relating to the selection sample image
indicates at least one of a number of times of matching, a matching rate, a statistical value for a number of the other sample images that match simultaneously, the other sample images that have matched simultaneously, a number of times of simultaneous matching with each of the other sample images that have matched simultaneously, the sample image with a number of times of simultaneous matching satisfying a predetermined condition among the other sample images that have matched simultaneously, and a degree of similarity to the other sample images that have matched simultaneously.

3. The processing apparatus according to claim 1, wherein the at least one processor is further configured to execute the one or more instructions to
search for, as the sample image matching the search query, the sample image with a degree of similarity to the search query being equal to or more than a reference value, and rank the sample image matching the search query in descending order of the degree of similarity, and
the aggregation information relating to the selection sample image
indicates at least one of a statistical value for the rank upon matching, a statistical value for the rank upon simultaneous matching of each of the other sample images that have matched simultaneously, a statistical value for a rank difference between the rank upon matching and the rank upon simultaneous matching of each of the other sample images that have matched simultaneously, and a history of a pair of the ranks of the other sample images that have matched simultaneously and the selection sample image.

4. The processing apparatus according to claim 1, wherein the at least one processor is further configured to execute the one or more instructions to
generate distribution information of a plurality of the sample images plotted on a reduced-dimensional graph after reducing dimensionality of a feature value of each of the sample images indicated by a multi-dimensional vector,
output the distribution information,
accept an input of selecting the selection sample image on the graph, and
output the aggregation information relating to the selected selection sample image.

5. The processing apparatus according to claim 4, wherein
the at least one processor is further configured to execute the one or more instructions to
highlight the sample image with a value for a predetermined item indicated by the aggregation information satisfying a highlighting condition among the sample images plotted on the graph.

6. The processing apparatus according to claim 5, wherein
the at least one processor is further configured to execute the one or more instructions to
set the highlighting condition, based on a user input.

7. The processing apparatus according claim 1, wherein the at least one processor is further configured to execute the one or more instructions to
rank-display a plurality of the sample images, based on a value for a predetermined item indicated by the aggregation information,
accept an input of selecting the selection sample image from among the rank-displayed plurality of the sample images, and
output the aggregation information relating to the selected selection sample image.

8. The processing apparatus according to claim 7, wherein
the at least one processor is further configured to execute the one or more instructions to
display, in the rank display, a value for a first item indicated by the aggregation information in association with each of a plurality of the sample images, and
display, as the aggregation information relating to the selected selection sample image, a value for a second item indicated by the aggregation information.

9. A processing method comprising,
by one or more computers:
acquiring a search query;
collating the search query with a plurality of sample images, and searching for the sample image matching the search query;
registering a result of the collation in a collation history indicating one or a plurality of the sample images matching in each time of the collation;
generating, based on the collation history, aggregation information relating to a result of the collation about a selection sample image among a plurality of the sample images; and
outputting the aggregation information.

10. The processing method according to claim 9, further comprising,
by the one or more computers,
searching for, as the sample image matching the search query, the sample image with a degree of similarity to the search query being equal to or more than a reference value, wherein
the aggregation information relating to the selection sample image
indicates at least one of a number of times of matching, a matching rate, a statistical value for a number of the other sample images that match simultaneously, the other sample images that have matched simultaneously, a number of times of simultaneous matching with each of the other sample images that have matched simultaneously, the sample image with a number of times of simultaneous matching satisfying a predetermined condition among the other sample images that have matched simultaneously, and a degree of similarity to the other sample images that have matched simultaneously.

11. The processing method according to claim 9, further comprising,
by the one or more computers,
searching for, as the sample image matching the search query, the sample image with a degree of similarity to the search query being equal to or more than a reference value, and ranks the sample image matching the search query in descending order of the degree of similarity, wherein
the aggregation information relating to the selection sample image
indicates at least one of a statistical value for the rank upon matching, a statistical value for the rank upon simultaneous matching of each of the other sample images that have matched simultaneously, a statistical value for a rank difference between the rank upon matching and the rank upon simultaneous matching of each of the other sample images that have matched simultaneously, and a history of a pair of the ranks of the other sample images that have matched simultaneously and the selection sample image.

12. The processing method according to claim 9, further comprising,
by the one or more computers:
generating distribution information of a plurality of the sample images plotted on a reduced-dimensional graph after reducing dimensionality of a feature value of each of the sample images indicated by a multi-dimensional vector;
outputting the distribution information;
accepting an input of selecting the selection sample image on the graph; and
outputting the aggregation information relating to the selected selection sample image.

13. The processing method according to claim 12, further comprising,
by the one or more computers,
highlighting the sample image with a value for a predetermined item indicated by the aggregation information satisfying a highlighting condition among the sample images plotted on the graph.

14. The processing method according to claim 13, further comprising,
by the one or more computers,
setting the highlighting condition, based on a user input.

15. A non-transitory computer-readable medium storing a program causing a computer to:
acquire a search query;
collate the search query with a plurality of sample images,
search for the sample image matching the search query;
register a result of the collation in a collation history indicating one or a plurality of the sample images matching in each time of the collation;
generate, based on the collation history, aggregation information relating to a result of the collation about a selection sample image among a plurality of the sample images; and
output the aggregation information.

16. The non-transitory computer-readable medium according to claim 15, wherein the program causing the computer to
search for, as the sample image matching the search query, the sample image with a degree of similarity to the search query being equal to or more than a reference value, and
the aggregation information relating to the selection sample image
indicates at least one of a number of times of matching, a matching rate, a statistical value for a number of the other sample images that match simultaneously, the other sample images that have matched simultaneously, a number of times of simultaneous matching with each of the other sample images that have matched simultaneously, the sample image with a number of times of simultaneous matching satisfying a predetermined condition among the other sample images that have matched simultaneously, and a degree of similarity to the other sample images that have matched simultaneously.

17. The non-transitory computer-readable medium according to claim 15, wherein the program causing the computer to
search for, as the sample image matching the search query, the sample image with a degree of similarity to the search query being equal to or more than a reference value, and rank the sample image matching the search query in descending order of the degree of similarity, and
the aggregation information relating to the selection sample image
indicates at least one of a statistical value for the rank upon matching, a statistical value for the rank upon simultaneous matching of each of the other sample images that have matched simultaneously, a statistical value for a rank difference between the rank upon matching and the rank upon simultaneous matching of each of the other sample images that have matched simultaneously, and a history of a pair of the ranks of the other sample images that have matched simultaneously and the selection sample image.

18. The non-transitory computer-readable medium according to claim 15, wherein the program causing the computer to
generate distribution information of a plurality of the sample images plotted on a reduced-dimensional graph after reducing dimensionality of a feature value of each of the sample images indicated by a multi-dimensional vector,
output the distribution information,
accept an input of selecting the selection sample image on the graph, and
output the aggregation information relating to the selected selection sample image.

19. The non-transitory computer-readable medium according to claim 18, wherein
the program causing the computer to
highlight the sample image with a value for a predetermined item indicated by the aggregation information satisfying a highlighting condition among the sample images plotted on the graph.

20. The non-transitory computer-readable medium according to claim 19, wherein
the program causing the computer to set the highlighting condition, based on a user input.
